(19) United States
(12) Patent Application Publication
(10) Pub. No.: US 2007/0224868 A1
(43) Pub. Date: Sep. 27, 2007

(54) Lockout device

(76) Inventor: Glenn P. Meekma, Menomonee Falls, WI (US)

Correspondence Address: CALFEE, HALTER & GRISWOLD LLP, 1400 MCDONALD INVESTMENT CENTER, 800 SUPERIOR AVENUE, CLEVELAND, OH, 44114, US

(21) Appl. No.: 11/726,190

(22) Filed: Mar. 21, 2007

Related U.S. Application Data
(60) Provisional application No. 60/784,148, filed on Mar. 21, 2006.

(51) Int. Cl. H01R 13/52

(52) U.S. Cl. 439/276

(57) ABSTRACT

A fitting lockout device includes first and second plate members each having proximal and distal end portions. The first plate member has at least a first cutout disposed between the proximal and distal end portions, and at least a first lock aperture disposed in the distal end portion. The second plate member has at least a second cutout disposed between the proximal and distal end portions, and at least a second lock aperture disposed in the distal end portion. The proximal end portion of the first plate member is pivotally connected to the proximal end portion of the second plate member such that the first and second plate members may be pivoted to align the first and second lock apertures for receipt of a locking member therethrough. When the first and second lock apertures are aligned, the first and second cutouts overlap to define an opening for securely retaining a recessed portion of a fitting.

### CROSS REFERENCE TO RELATED APPLICATIONS

This application claims the benefit of the U.S. Provisional Patent Application Ser. No. 60/784,148, entitled “Locking Device” and filed Mar. 21, 2006, the entire disclosure of which is hereby incorporated by reference, to the extent that it is not conflicting with the present application.

### FIELD

The present invention relates to a lockout device and to a lockout device for preventing attachment of a fitting to a mating connection.

### BACKGROUND

Various conduits, such as electrical conduits and fluid system conduits, including, for example, tubing, pipe, and hose, may be connected to various equipment using many types of fittings in a variety of commercial or industrial applications. Under some circumstances, such as during equipment maintenance or system shutdown, these fitting connections may be uncoupled to disconnect the equipment for a source, such as, for example, a source of electricity or pressurized fluid. In such circumstances, unauthorized or accidental reconnection of the fitting connection may cause injury to personnel or damage to equipment.

### SUMMARY

The present application contemplates various inventive features for a lockout device for obstructing use of or connection with a fitting for a conduit. While the exemplary embodiment illustrated and described herein is used with a quick-disconnect fitting for a pneumatic supply line, one or more of the inventive features described herein may also be used on any number of fitting types. As used herein, “fitting” may include any one or more of a variety of connections, including, for example, tube fittings, pipe fittings, quick-disconnect couplings, hose connections, or electrical connections, and may comprise separate fitting components or fitting connections integral to another component, such as a valve or piece of equipment.

Accordingly, in one embodiment of the present application, a fitting lockout device includes first and second plate members each having proximal and distal end portions. The first plate member has at least a first cutout disposed between the proximal and distal end portions and at least a first lock aperture disposed in the distal end portion. The second plate member has at least a second cutout disposed between the proximal and distal end portions, and at least a second lock aperture disposed in the distal end portion. The proximal end portion of the first plate member is pivotally connected to the proximal end portion of the second plate member such that the first and second plate members may be pivoted to align the first and second lock apertures for receipt of a locking member therethrough. When the first and second lock apertures are aligned, the first and second cutouts overlap to define an opening for securely retaining an outer recessed portion of a fitting.

### BRIEF DESCRIPTION OF THE DRAWINGS

Further features and advantages of the invention will become apparent from the following detailed description made with reference to the accompanying drawings, wherein:

FIG. 1 is a front view of a lockout device in an open position;

FIG. 2 is a front view of the lockout device of FIG. 1, shown in a closed or lockout position;

FIG. 3 is a front view of the locking device of FIG. 1, showing the lockout device in a closed position around a quick disconnect fitting;

FIG. 4 is a side view of the locking device and quick disconnect fitting assembly shown in FIG. 3; and

FIG. 5 is a perspective view of the locking device and quick disconnect fitting assembly shown in FIG. 3.

### DETAILED DESCRIPTION OF THE INVENTION

This Detailed Description of the Invention merely describes embodiments of the invention and is not intended to limit the scope of the specification or claims in any way. Indeed, the invention as described is broader than and unlimited by the preferred embodiments, and the terms used have their full ordinary meaning.

According to an inventive aspect of the present application, a fitting may be locked out from coupling with a mating connection by securing a device to the fitting that obstructs coupling, and may, but need not, be locked in this lockout condition to prevent accidental or unauthorized use of the fitting. While many different types of devices may be secured to a fitting, in one embodiment, a device includes two or more plates that may be positioned to engage and retain an outer recessed portion of the fitting, with the plates being lockable in this condition to restrict use of the fitting. As described herein, a recessed portion may include a groove, slot, indentation or other such feature. This outer recessed port may, but need not, be proximate to or engaged by a mating connection, such that a lockout device secured to the outer recessed portion prevents connection of the fitting with the mating connection. As one example, a conventional quick disconnect fitting includes an annular groove around a circumference of the fitting, and a mating connection engages the groove to connect the fitting with the mating connection. By securing a lockout device to the quick-disconnect fitting's annular groove, connection of the fitting with the mating connection is effectively prevented. In other embodiments, the device may be sized to interfere with the equipment to which the fitting would otherwise be connectable.

To be secured with or to retain an outer recessed portion on a fitting, a lockout device may include first and second plate members pivotally connected to each other such that the first and second plate members may be pivoted into secure engagement with an outer recessed portion of the fitting. The first and second plate members may each include cutouts that converge, overlap, or otherwise align when the plate members are pivoted to engagement with the fitting, such that the cutouts form an opening sized to retain the outer recessed portion of the fitting in the device's lockout position. While the plate members may be provided in many different shapes, in one embodiment, the plate members are elongated and substantially rectangular in shape.

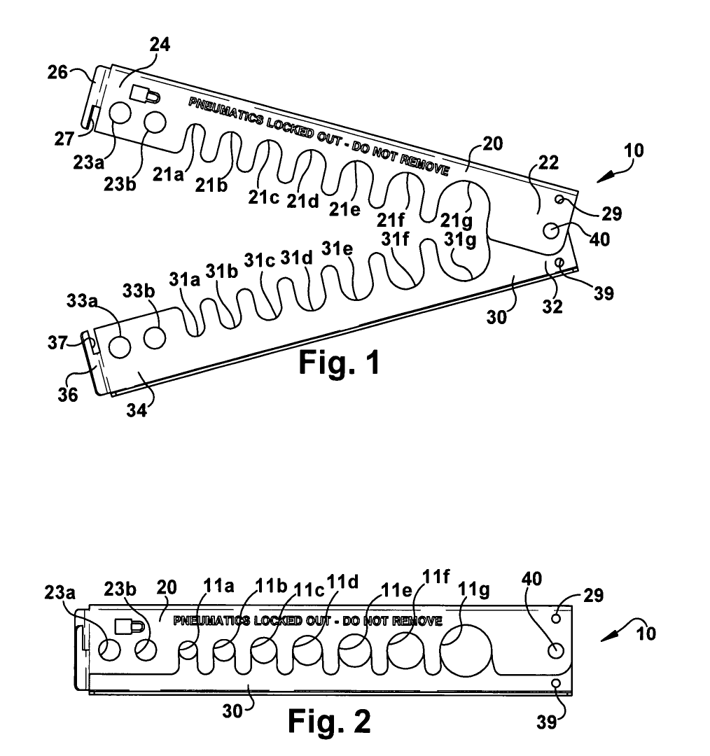

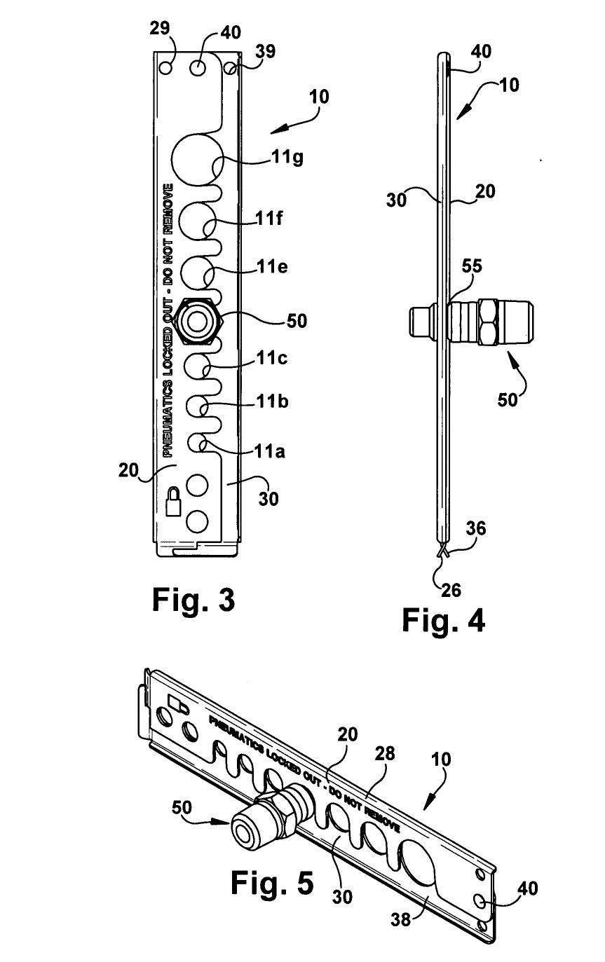

FIGS. 1-5 illustrate an exemplary lockout device 10 for a male quick-connect type fitting 50 (see FIGS. 3, 4, and 5) having an annular outer groove 55 (see FIG. 4). The lockout device includes first and second plate members 20, 30 with each plate member 20, 30 having a proximal end portion 22, 32 and a distal end portion 24, 34. The proximal end portion 32 of the second plate member 30 is pivotally connected to the proximal end portion 22 of the first plate member 20, for example, using a rivet 40 or other such fastener, such that each of the first and second plate members 20, 30 are pivotable with respect to each other. In certain respects this construction functions like a hinge between the two plates.

To receive and retain the outer recessed portion 55 of the fitting 50, plate members 20, 30 may include a cutout 21d, 31d (see FIG. 1) sized to receive the outer recessed portion 55 of the fitting 50. While the cutouts may comprise holes in the plates, in one embodiment, the cutouts comprise slots or notches along a side edge of each plate. As shown in FIG. 1, the first and second plates may each include a set of cutouts 21a-g, 31a-g for receiving multiple fittings. As shown, the cutouts 21a-g, 31a-g may be provided in a range of sizes to accommodate a range of fitting types and sizes. For example, the plate cutouts may be sized to accommodate one or more sizes (for example, ¼″, ½″, and ¾″) of quick-disconnect fittings of various types, including, for example, industrial shape, TRU-FLATE shape, Schrader shape, ARO shape, high flow straight, Lincoln shape, compact, European shape and Japanese shape fittings.

When the first and second plate members 20, 30 are pivoted to a lockout position, the cutouts 21a-g, 31a-g converge, overlap, or align to form openings 11a-g for securely retaining the outer recessed portion of one or more fittings, such as the annular groove 55 of the fitting 50 shown in FIGS. 3-5. Each opening 11a-g may be sized to be at least slightly greater in diameter than the outer recessed portion of the fitting it is intended to retain, while being smaller in diameter than portions of the fitting adjacent to the outer recessed portion, thereby retaining the lockout device 10 on the fitting in the lockout position. While the illustrated openings 11a-g are generally circular in shape, cutouts may be configured to form openings of varying shapes. Also, while the plate members 20, 30 are shown as being generally flat, thin, and rectangular in shape, a variety of shapes, thicknesses and contours may be used.

To secure the lockout device 10 in the lockout position, one or more lock apertures 23a-b, 33a-b may be provided in the distal portions 24, 34 of the first and second plate members 20, 30. When the first and second plate members 20, 30 are pivoted to the lockout position, the lock apertures 23a-b, 33a-b align to receive one or more lock members, such as, for example, the shackle of a padlock (not shown), therethrough. The insertion of a locking member through aligned lock apertures 23a-b, 33a-b prevents the lockout device 10 from being pivoted to an open position. The use of multiple locking members through multiple lock apertures 23a-b, 33a-b may provide additional security from unauthorized use of the fitting, for example, by requiring multiple personnel to unlock the lockout device 10.

In various embodiments, to move the lockout device 10 to the lockout condition, the first and second plates may be pivoted either until the plates engage the fitting positioned in the corresponding cutouts or until the lock apertures align with each other. In one embodiment, the plate members may be configured such that the plate members abut each other in the lockout position, thereby facilitating alignment of the lock apertures and preventing over-tightening of the plates on the fitting. Conversely, to open the lockout device to receive a fitting, the plates are pivoted to an open position in which the two plates 20, 30 do not overlap in the vicinity of the cutouts 21a-g, 31a-g, and the cutouts may not be aligned. As one example, shown in the illustrated embodiment, the first and second plate members 20, 30 may include notched blade portions 26, 36 configured to abut each other in the lockout position. As best shown in FIG. 4, the notched blade portions 26, 36 may be bent at an angle from the distal portions 24, 34 of the plate members 20, 30, and may include slotted portions 27, 37 to interlock the notched blade portion 26, 36 in the lockout position.

The lockout device 10 may be provided with additional features. For example, one or both of the plate members 20, 30 may be provided with a folded or flanged outside edge 28, 38 to reinforce or strengthen the plate members 20, 30 (see FIG. 5). While the plate members 20, 30 may be provided in many different materials, in one embodiment, the plate members may be constructed from stainless steel for strength and corrosion resistance properties. As another example, one or both of the plate members 20, 30 may be provided with a hole 29, 39 for receiving a cable or lanyard to attach the lockout device to a structure, such as, for example, a machine or piece of equipment with which the fitting to be locked out is used, to prevent loss of the device. As still another example, one or both of the plate members 20, 30 may be marked with text or symbols identifying the locked out condition of the fitting (shown, for example, in FIGS. 1, 2, 3, and 5), the reasons for lockout, and/or the personnel who locked out the fitting.

According to another inventive aspect of the present application, by providing a lockout device having plate members with substantially identical features, such as, for example, substantially identical size, cutouts, lock apertures, and notched blade portions, manufacturing costs may be reduced, as the same manufacturing operations (such as stamping, cutting, bending, or other such procedures) may be performed on both plate members. In the illustrated embodiment, the first and second plate members 20, 30 are substantially identical to each other. As a result, only one type of plate is manufactured to produce the lockout device, thereby reducing manufacturing costs.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A lockout device for obstructing use of a fitting having an outer recessed portion, the lockout device comprising:
a first plate member comprising proximal and distal end portions, at least a first cutout disposed between the proximal and distal end portions, and at least a first lock aperture disposed in the distal end portion; and
a second plate member comprising proximal and distal end portions, at least a second cutout disposed between the proximal and distal end portions, and at least a second lock aperture disposed in the distal end portion;
wherein the proximal end portion of the first plate member is pivotally connected to the proximal end portion of the second plate member such that the first and second plate members may be pivoted to align the first and second lock apertures for receipt of a locking member therethrough;
further wherein when the first and second lock apertures are aligned, the first and second cutouts overlap to define an opening for securely retaining the outer recessed portion of the fitting.

2. The lockout device of claim 1, wherein the first plate member comprises a first set of cutouts and the second plate member comprises a corresponding second set of cutouts, wherein when the first and second lock apertures are aligned, each of the first set of cutouts overlaps a corresponding one of the second set of cutouts to define an opening for retaining the outer recessed portion of a corresponding fitting.

3. The lockout device of claim 2, wherein when the first and second lock apertures are aligned, at least two of the openings defined by the corresponding ones of the first and second cutout are sized to accommodate different sized fittings.

4. The lockout device of claim 1, wherein the first and second plate members each comprise a plurality of lock apertures.

5. The lockout device of claim 1, further comprising a first notched blade portion extending from the distal end portion of the first plate member, and a second notched blade portion extending from the distal end portion of the second plate member, wherein the first and second notched blade portions are configured to abut each other when the first and second lock apertures are aligned.

6. The lockout device of claim 5, wherein the first and second notched blade portions comprise interlocking slots.

7. The lockout device of claim 5, wherein the first and second notched blade portions are each bent at an angle with respect to the corresponding distal end portion.

8. The lockout device of claim 5, wherein the first and second notched blade portions are substantially identical.

9. The lockout device of claim 1, wherein the first cutout extends to a side edge of the first plate member, and the second cutout extends to a side edge of the second plate member.

10. The lockout device of claim 1, wherein the first and second cutouts are substantially identical.

11. The lockout device of claim 1, wherein the first and second plate members are substantially identical.

12. A lockout arrangement for a conduit, the lockout arrangement comprising:
a fitting for assembly with the conduit, the fitting comprising an outer recessed portion;
a first plate member comprising proximal and distal end portions, at least a first cutout disposed between the proximal and distal end portions, and at least a first lock aperture disposed in the distal end portion; and
a second plate member comprising proximal and distal end portions, at least a second cutout disposed between the proximal and distal end portions, and at least a second lock aperture disposed in the distal end portion;
wherein the proximal end portion of the first plate member is pivotally connected to the proximal end portion of the second plate member such that the first and second plate members may be pivoted to align the first and second lock apertures for receipt of a locking member therethrough;
further wherein when the first and second lock apertures are aligned, the first and second cutouts overlap to define an opening for securely retaining the outer recessed portion of the fitting.

13. The lockout arrangement of claim 12, wherein the first plate member further comprises a third cutout disposed between the proximal and distal end portions, and the second plate member comprises a fourth cutout, wherein when the first and second lock apertures are aligned, the third and fourth cutouts overlap to define a second opening for securely retaining an outer recessed portion of a second fitting.

14. The lockout arrangement of claim 12, wherein the outer recessed portion of the fitting is configured to engage a corresponding feature on a mating connection to connect the fitting to the mating connection, such that retention of the outer recessed portion by the first and second plate member prevents connection of the fitting with the mating connection.

15. A method for obstructing use of a fitting having an outer recessed portion, the method comprising:
providing a first plate member comprising at least a first cutout extending from a side edge of the first plate member, and at least a first lock aperture disposed in a distal end portion of the first plate member;
providing a second plate member comprising at least a second cutout extending from a side edge of the second plate member, and at least a second lock aperture disposed in a distal end portion of the second plate member;
pivotally connecting a proximal end portion of the first plate member to a proximal end portion of the second plate member;
positioning the first and second plate members to receive an outer recessed portion of a fitting;
pivoting at least one of the first and second plate members to a lockout position in which the outer recessed portion of the fitting is securely retained between the first and second cutouts; and
locking the first and second plate members in the lockout position.

16. The method of claim 15, wherein locking the first and second plate members in the lockout position comprises inserting a locking device through aligned lock apertures in the first and second plate members.

17. The method of claim 15, wherein pivoting at least one of the first and second plate members to the lockout position comprises abutting a first notched blade portion on the first plate member with a second notched blade portion on the second plate member.

18. The method of claim 15, further comprising securing the first and second plate members to a structure by a lanyard assembled with at least one of the first and second plate members.

19. The method of claim 15, wherein pivotally connecting a proximal end portion of the first plate member to a proximal end portion of the second plate member comprises riveting the first plate member to the second plate member.

20. The method of claim 15, wherein providing the second plate member comprises providing a plate member substantially identical to the first plate member.
